(19) United States
(12) Patent Application Publication
(10) Pub. No.: US 2009/0198512 A1
(43) Pub. Date: Aug. 6, 2009

(54) MEDICAL FILE CARRIER COVER

(76) Inventor: Marie Faircloth, Baltimore, MD (US)

Correspondence Address: Stephen B. Salai, Esq.;Harter Secrest & Emery LLP, 1600 Bausch & Lomb Place, Rochester, NY, 14604-2711, US

(21) Appl. No.: 12/026,238

(22) Filed: Feb. 5, 2008

(51) Int. Cl. G06Q 50/00; B42D 3/04; B42F 13/00; B23P 11/00

(52) U.S. Cl. 705/2; 281/34; 402/73; 29/428

(57) ABSTRACT

A method of storing a medical file carrier in a healthcare facility includes disposing a first portion of the medical file carrier in a first pocket of a removable carrier cover, substantially covering an outer surface of the medical file carrier with a surface of the carrier cover, and defining a non-covered region exposing a second portion of the medical file carrier for review in the healthcare facility.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to equipment used in healthcare facilities, and, in particular, to equipment configured to prohibit the spread of pathogens in a healthcare facility.

2. Description of Related Art

Healthcare facilities such as hospitals, clinics, and trauma centers utilize a wide array of equipment for the treatment of patients. This equipment is used by a large number of healthcare professionals such as nurses, doctors, specialists, administrative staff members, and other facility personnel. Some of the equipment, such as medical file carriers, can be used to house medical charts, records, and other information related to a particular patient. Such information can be placed in the file carrier by the administrative staff of the healthcare facility for use in the treatment of the patient, and a single file carrier can be used multiple times for multiple patients. The file carrier can also be stored in a variety of different places throughout the healthcare facility, such as on a patient's nightstand, on a patient's bed, in a chart holder at a nurse's station, and in file carrier storage racks.

Although known file carriers can effectively organize pertinent information related to the current treatment and medical history of the patient, using such file carriers can often cause problems for the healthcare facility and, ultimately, the patient. For example, file carriers utilized by healthcare facilities are rarely, if ever, sanitized. Thus, harmful pathogens such as, for example, vancomycin-resistant Enterococcus faecium (“VRE”) and methicillin-resistant Staphylococcus aureus (“MRSA”) often found in healthcare facilities can be carried by the file carriers from patient to patient. As a result, the frequency of nosocomial infections among patients in healthcare facilities is on the rise. Such infections can include urinary tract infections, various pneumonias, and other illnesses.

To stop the spread of nosocomial infections, many healthcare facilities require the use of over all infection control procedures and general precautions using anti-microbial agents by all medical personnel prior to contact with each patient. The routine use of such agents, however, has led to the emergence of resistant strains of these harmful pathogens. In addition, while thorough hand washing by medical personnel can reduce the spread of nosocomial infections, such repeated washing with common anti-microbial soaps, wipes, or rubs can cause uncomfortable dryness and/or cracking of the skin. Moreover, even the most responsible healthcare facility staff member can sometimes fail to disinfect his or her hands prior to contact with a patient.

The disclosed system and method are directed towards overcoming one or more of the problems set forth above.

### SUMMARY OF THE INVENTION

In an exemplary embodiment of the present disclosure, a method of storing a medical file carrier in a healthcare facility includes disposing a first portion of the medical file carrier in a first pocket of a removable carrier cover, substantially covering an outer surface of the medical file carrier with a surface of the carrier cover, and defining a non-covered region exposing a second portion of the medical file carrier for review in the healthcare facility.

In another exemplary embodiment of the present disclosure, a method of storing medical file carriers in a healthcare facility includes disposing a first medical file carrier in a removable carrier cover, storing the first medical file carrier at a desired location within the healthcare facility, and removing the first medical file carrier from the removable carrier cover. The method also includes sanitizing the removable carrier cover and disposing a second medical file carrier in the sanitized removable carrier cover.

In a further exemplary embodiment of the present disclosure, a method of storing medical file carriers in a healthcare facility includes removing a medical file carrier from a first removable carrier cover, removing a first medical record from the medical file carrier and disposing a second medical record in the medical file carrier, and sanitizing a second removable carrier cover. The method also includes disposing the medical file carrier in the second removable carrier cover.

In still another exemplary embodiment of the present disclosure, a removable carrier cover includes a pocket configured to removably accept a portion of a medical file carrier, a first arm defining a portion of the pocket and extending therefrom to cover a first side of the medical file carrier, and a second arm disposed opposite the first arm and configured to cover a second side of the medical file carrier. The second arm is connected to the first wall, and the carrier cover further includes an orifice defined by at least one of the first and second arms. The orifice is configured to expose a portion of the medical file carrier.

In a further exemplary embodiment of the present disclosure, a method of forming a one-piece removable carrier cover for use with a medical file carrier includes connecting a first side of a piece of material to a back surface of the material, and connecting a second side of the piece of material to the back surface to form a pocket configured to removably accept a portion of a medical file carrier. The method also includes forming an orifice in the back surface, the orifice configured to expose a status identifier of the medical file carrier.

### BRIEF DESCRIPTION OF THE DRAWINGS

FIG. 1 is an isometric view of a medical file carrier according to an exemplary embodiment of the present disclosure.

FIG. 2 is an alternate view of the medical file carrier illustrated in FIG. 1.

FIG. 3 is an isometric view of a medical file carrier according to another exemplary embodiment of the present disclosure.

FIG. 4 is an alternate view of the medical file carrier illustrated in FIG. 3.

### DETAILED DESCRIPTION OF THE DRAWINGS

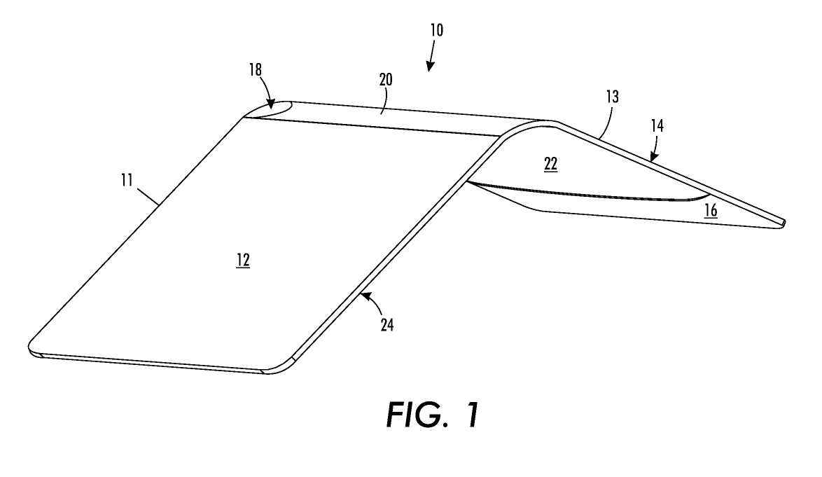

FIG. 1 illustrates a carrier cover 10 according to an exemplary embodiment of the present disclosure. The carrier cover 10 can include a first arm 11 and a second arm 13, and the first and second arms 11, 13 can be joined along a spine 20 of the carrier cover 10. The first arm 11 can define a front surface 12 and a back surface 24, and the second arm 13 can also define a front surface 14 and a back surface 22.

The carrier cover 10 can be made from a single sheet of material or, in the alternative, the carrier cover 10 can be made from a plurality of separate pieces of material that are sewn, adhered, bonded, and/or otherwise joined together. In an exemplary embodiment, at least a portion of the carrier cover 10 can be threaded and/or otherwise formed using a surger or other known sewing apparatus. Such portions can include, for example, the spine 20, one or more pockets (discussed below), and/or one or more seams (discussed below) of the carrier cover 10.

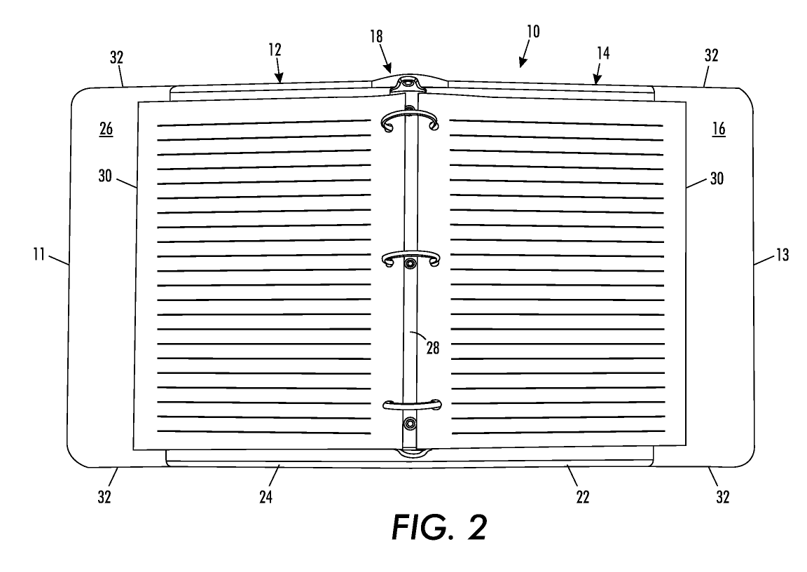

The carrier cover 10 can be any size, shape, and/or other configuration known in the art. In an exemplary embodiment, the carrier cover 10 can be sized, shaped, and/or otherwise configured to receive a medical file carrier 28 (FIG. 2). In particular, the carrier cover 10 can be, for example, substantially square, substantially rectangular, and/or any other shape, and may be substantially the same size and/or shape as the file carrier 28 with which it is used.

The carrier cover 10 can be formed from any formable, non-porous, semi-porous, or antimicrobial material known in the art. Such materials can include, for example, cotton, nylon, spandex, plastic, and/or any other cloth, mesh, or other material known in the art. Such materials can also include those employing the antimicrobial properties of known chemicals such as, for example, chlorine to kill pathogens. Such materials include HaloShield® made by Medline Industries. In an exemplary embodiment, the carrier cover 10 can be formed from a sheeting fabric similar to the fabric used in the manufacture of bedding. Such fabric can be semi-porous and launderable. As a result, exemplary carrier covers 10 made from sheeting fabric can be easily sanitized after use. Such carrier covers 10 can be used multiple times and can have a relatively long life span within a healthcare facility.

In another exemplary embodiment, the carrier cover 10 can be made from a substantially non-porous, substantially nylon mesh material. In such an exemplary embodiment, the carrier cover 10 can be launderable and, thus, can be reuseable and easily sanitizeable.

In an exemplary embodiment, the semi-porous and non-porous carrier covers 10 described herein can assist in forming a pathogen barrier between a medical file carrier 28 and items disposed within the healthcare facility. Forming such a barrier can substantially eliminate the transmission of pathogens to a medical file carrier disposed within the carrier cover 10 and, accordingly, can substantially eliminate the transmission of pathogens from patient to patient via the medical file carrier 28. Such pathogens can cause nosocomial infections in patients treated at the healthcare facility. It is understood that both the semi-porous and non-porous carrier covers 10 described herein can be effective at forming such a barrier between a medical file carrier 28 and either airborne pathogens or pathogens carried in a fluid. The non-porous carrier covers 10 of the present disclosure can be particularly effective at forming a protective barrier between a medical file carrier 28 and pathogens carried by liquids such as, for example, blood, urine, or other bodily fluids.

In a further exemplary embodiment, the carrier cover 10 can be made from a substantially non-porous disposable material, such as the material used in the fabrication of isolation gowns used in healthcare facilities during, for example, surgery and/or other invasive medical procedures. In such an exemplary embodiment, the carrier cover 10 can assist in forming a pathogen barrier between a medical file carrier 28 and items disposed within the healthcare facility, and can be discarded after use. It is understood that the type and/or configuration of material used to fabricate the carrier cover 10 may depend on a number of factors such as, for example, the level of protective barrier performance required for the patient, cost, availability, and/or the preferences of the healthcare facility in which the carrier cover 10 is used.

As shown in FIG. 1, a portion of the carrier cover 10 can assist in defining a non-covered region 18. The non-covered region 18 can be disposed anywhere along the carrier cover 10 and, in an exemplary embodiment, the non-covered region 18 can be disclosed proximate the spine 20. In such an exemplary embodiment, the non-covered region 18 can be formed, at least in part, by a portion of the first arm 11 and a portion of the second arm 13. The non-covered region 18 may have any shape, size, and/or other configuration known in the art. In an exemplary embodiment, the non-covered region 18 may be sized, shaped, located, and/or otherwise configured to expose a portion of, for example, a medical file carrier 28 (FIG. 2), medical chart, and/or other item disposed within the carrier cover 10. The portion of the medical file carrier 28 that is exposed by the non-covered region 18 can be, for example, a spine and/or any other portion of the medical file carrier 28 having information pertaining to the patient. Such information can include, for example, patient identification information, patient status information, and treating physician information. In an exemplary embodiment, the portion of the medical file carrier 28 exposed for review by the non-covered region 18 can be a patient status indicator mounted and/or otherwise disposed on the medical file carrier 28. The patient status indicator may provide a physician and/or healthcare facility staff member with information related to the health, condition, and/or status of a patient.

FIG. 2 illustrates an exemplary embodiment of the present disclosure in which a medical file carrier 28 has been disposed within a carrier cover 10. As shown in FIG. 2, the non-covered region 18 can be disposed proximate a spine of the medical file carrier 28 and, in an exemplary embodiment, the medical file carrier 28 can comprise a three-ring binder. It is understood that the medical file carrier 28 can be any apparatus configured to bind and/or otherwise organize medical records, charts, and/or other documents associated with a patient in a healthcare facility. In an exemplary embodiment, such medical records 30 can comprise separate sheets of paper and, in such an embodiment, the medical records 30 can be laminated. It is understood that the medical file carrier 28 can be any size, shape, and/or configuration known in the art and such medical file carriers 28 can be, for example, ½-inch, 1-inch, 1½-inch, 2-inch, 2½-inch, 3-inch, and/or any other appropriately sized binders known in the art. Such medical file carriers 28 can also include a portion where information such as, for example, the patient information discussed above can be displayed. This portion can comprise a patient status indicator, and it is understood that, as discussed above, the non-covered region 18 may be positioned such that this portion of the medical file carrier 28 can be exposed for review in the healthcare facility.

As shown in FIG. 2, in an exemplary embodiment of the present disclosure the first arm 11 of the carrier cover 10 can define a first pocket 26 and the second arm 13 can define a second pocket 16. The first and second pockets 26, 16 can be formed by stitching, adhering, sewing, and/or otherwise joining a portion of the first and second arms 11, 13 onto themselves, respectively. Accordingly, the carrier cover 10 can define one or more seams 32 disposed proximate the edges of the first and second arms 11, 13. Alternatively, in an additional exemplary embodiment in which the carrier cover 10 is formed without stitching, sewing, and/or adhering, the seams 32 can be omitted. For example, carrier covers 10 formed through a molding process can be formed without seams 32. It is understood that in such an exemplary embodiment, the carrier cover 10 may be made out of any of the materials discussed above and may also be made out of plastic and/or other moldable or heat formable materials.

The first and second pockets 26, 16 of the carrier cover 10 can be shaped and/or sized to accept a leg of the medical file carrier 28. As shown in FIG. 2, a leg of the medical file carrier 28 can be disposed within the first pocket 26 and another leg of the medical file carrier 28 can be disposed within the second pocket 16. In such an exemplary embodiment, an outer surface of the medical file carrier 28 can be disposed along the back surfaces 24, 22 of the carrier cover 10. In such an exemplary embodiment, when the medical file carrier 28 is substantially closed, the front surfaces 12, 14 of the carrier cover 10 can assist in forming a pathogen barrier between the medical file carrier 28 and items disposed within the healthcare facility. In particular, the pathogen barrier can be formed between the medical file carrier 28 and pathogens residing at different locations within the healthcare facility.

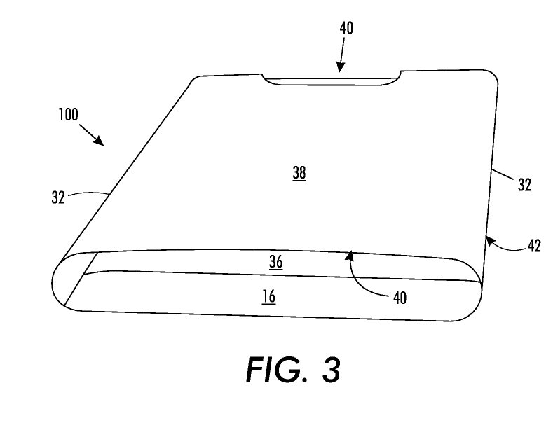

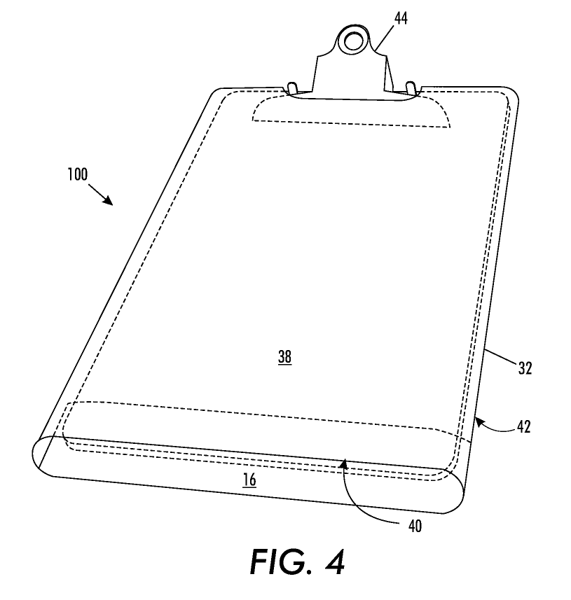

FIGS. 3 and 4 illustrate a carrier cover 100 according to an additional exemplary embodiment of the present disclosure. Where possible, the item numbers associated with components of the carrier cover 10 illustrated in FIGS. 1 and 2 have been used to identify like components of the carrier cover 100. As shown in FIG. 4, the carrier cover 100 can be configured to accept a medical file carrier 44 comprising a clipboard. The carrier cover 100 can comprise front surfaces 38, 42 and back surfaces 40, 36. The carrier cover 100 can also define one or more seams 32 disposed between and/or otherwise joining the front surface 38 to the front surface 42. In an additional exemplary embodiment, it is understood that the seams 32 can join the back surface 40 to the back surface 36. In still another exemplary embodiment of the present disclosure in which the carrier cover 100 is formed without stitching, adhering, threading, and/or otherwise joining the front surfaces 38, 42 or the back surfaces 40, 36, it is understood that the seams 32 illustrated in FIGS. 3 and 4 can be omitted.

As shown in FIGS. 3 and 4, the carrier cover 100 can comprise a non-covered region 40 and at least one pocket 26. It is understood that the size, shape, configuration, material, and/or other characteristics of the carrier cover 100 can be substantially the same as those described above with respect to the carrier cover 10 illustrated in FIGS. 1 and 2. For example, the pocket 26 can be sized, shaped, located, and/or otherwise configured to accept a portion of the medical file carrier 44 disposed within the carrier cover 100. As shown in FIG. 4, the non-covered region 40 can be sized, shaped, and/or otherwise configured to expose a portion of the medical file carrier 44 for review in a healthcare facility and can also be sized to expose, for example, a clip of the medical file carrier 44. It is understood that the non-covered region 40 can also expose a portion of the medical file carrier 44 containing patient information and the exposed portion may comprise a patient status identifier.

The carrier covers 10, 100, described herein, can be used in healthcare facilities such as, for example, hospitals, clinics, and trauma centers to house and/or otherwise protect medical file carriers 28, 44 used in patient care. The carrier covers 10, 100 of the present disclosure can be configured to protect the medical file carriers 28, 44 from pathogens within the healthcare facility and, ultimately, can assist in preventing the transmission of such pathogens between patients wherein the same medical file carrier 28, 44 is used to carry files pertaining to multiple patients. For ease of discussion, the carrier cover 10 of FIGS. 1 and 2 will be discussed for the duration of this disclosure unless otherwise noted.

According to an exemplary embodiment of the present disclosure, a medical file carrier 28 can be stored in a healthcare facility by disposing a first portion of the medical file carrier 28 in the first pocket 26 of the carrier cover 10. Once disposed therein, an outer surface of the medical file carrier 28 can be substantially covered with one or more surfaces of the carrier cover 10. Such surfaces of the carrier cover 10 can include, for example, the back surfaces 22, 24.

Once a new first portion of the medical file carrier 28 has been disposed in the first pocket 26, a second portion of the medical file carrier 28 can be disposed in the second pocket 16 of the carrier cover 10. It is understood that the first and second portions of the medical file carrier 28 can comprise the first and second legs of the medical file carrier 28 discussed above. It is also understood that, as shown in FIG. 4, the first portion of the medical file carrier 44 can be a leg of a clipboard.

With continued reference to FIGS. 1 and 2, once the medical file carrier 28 is disposed within the carrier cover 10, the medical file carrier 28 can be substantially closed and the non-covered region 18 defined by a portion of the carrier cover 10 can substantially expose a portion of the medical file carrier 28 for review in healthcare facilities. It is understood that, as shown in FIG. 2, the exposed portion of the medical file carrier 28 can be a patient status identifier of the medical file carrier 28 displaying, for example, status of the patient, and/or other patient information. Alternatively, as shown in FIG. 4, the portion exposed by the non-covered region 40 can be a clip of the medical file carrier 44.

Disposing the portions of the medical file carrier 28 within the pockets 26, 16 of the carrier cover 10, as illustrated in FIG. 2, assists in forming a pathogen barrier between the medical file carrier 28 and other items disposed within the healthcare facility. It is understood that the medical file carrier 28 can be removed from the carrier cover 10, at which time the carrier cover 10 can be discarded. Alternatively, upon removing the medical file carrier 28 from the removable carrier cover 10, the carrier cover 10 can be laundered and/or otherwise sanitized to remove any pathogens disposed thereon. After laundering the carrier cover 10, the carrier cover 10 can be utilized with the same medical file carrier 28 or with a new medical file carrier 28.

Accordingly, an alternative method of storing a medical file carrier 28 in a healthcare facility can include removing the medical file carrier 28 from a first carrier cover 10, removing any medical records 30 from the medical file carrier 28, and disposing a second medical record 30 within the medical file carrier 28. Such a method could also include sanitizing a second removable carrier cover 10 and disposing the same medical file carrier 28 in the second carrier cover 10. In such an exemplary embodiment, removing the first medical record from the medical file carrier 28 can comprise opening a three-ringed binder or opening a clip of a clipboard.

Other embodiments of the disclosed carrier covers 10, 100 will be apparent to those skilled in the art from consideration of this specification. It is intended that the specification and examples be considered as exemplary only, with the true scope of the invention being indicated by the following claims.

What is claimed is:

1. A method of storing a medical file carrier in a healthcare facility, comprising:
(a) disposing a first portion of the medical file carrier in a first pocket of a removable carrier cover;
(b) substantially covering an outer surface of the medical file carrier with a surface of the carrier cover; and
(c) defining a non-covered region exposing a second portion of the medical file carrier for review in the healthcare facility.

2. The method of claim 1, wherein the second portion comprises one of a clip and a patient status identifier.

3. The method of claim 1, wherein the first portion of the medical file carrier is a leg of a ringed binder.

4. The method of claim 1, wherein the first portion of the medical file carrier is a leg of a clipboard.

5. The method of claim 1, wherein the removable carrier cover is made from a non-porous material.

6. The method of claim 1, wherein disposing a first portion of the medical file carrier in the first pocket of the removable cover assists in forming a pathogen barrier between the medical file carrier and items disposed within the healthcare facility.

7. The method of claim 1, further including removing the medical file carrier from the removable carrier cover and discarding the removable carrier cover.

8. The method of claim 1, further including removing the medical file carrier from the removable carrier cover and laundering the removable carrier cover.

9. A method of storing medical file carriers in a healthcare facility, comprising:
(a) disposing a first medical file carrier in a removable carrier cover;
(b) storing the first medical file carrier at a desired location within the healthcare facility;
(c) removing the first medical file carrier from the removable carrier cover;
(d) sanitizing the removable carrier cover; and
(e) disposing a second medical file carrier in the sanitized removable carrier cover.

10. The method of claim 9, wherein sanitizing the removable carrier cover comprises laundering the removable carrier cover to substantially remove pathogens disposed thereon.

11. The method of claim 9, wherein the desired location is one of a nurse station and a patient room.

12. The method of claim 9, wherein the first and second medical file carriers are ringed binders.

13. The method of claim 9, wherein disposing a first medical file carrier in a removable carrier cover includes exposing a portion of the medical file carrier for review in the healthcare facility.

14. The method of claim 9, wherein disposing the first medical file carrier in the removable carrier cover includes inserting a portion of the medical file carrier into a pocket defined by the removable carrier cover.

15. A method of storing medical file carriers in a healthcare facility, comprising:
(a) removing a medical file carrier from a first removable carrier cover;
(b) removing a first medical record from the medical file carrier and disposing a second medical record in the medical file carrier;
(c) sanitizing a second removable carrier cover; and
(d) disposing the medical file carrier in the second removable carrier cover.

16. The method of claim 15, wherein removing the first medical record from the medical file carrier comprises opening a ringed binder.

17. The method of claim 15, wherein disposing the medical file carrier in the second removable carrier cover includes exposing a portion of the medical file carrier for review in the healthcare facility.

18. The method of claim 15, wherein disposing the medical file carrier in the second removable carrier cover includes inserting a portion of the medical file carrier into a pocket defined by the second removable carrier cover.

19. A removable carrier cover, comprising:
(a) a pocket configured to removably accept a portion of a medical file carrier;
(b) a first arm defining a portion of the pocket and extending therefrom to cover a first side of the medical file carrier;
(c) a second arm disposed opposite the first arm and configured to cover a second side of the medical file carrier, the second arm being connected to the first wall; and
(d) an orifice defined by at least one of the first and second arms; the orifice configured to expose a portion of the medical file carrier.

20. The removable carrier cover of claim 19, wherein the removable file carrier is made from a single piece of material.

21. The removable carrier cover of claim 19, wherein the removable file carrier is made from a non-porous material.

22. A method of forming a one-piece removable carrier cover for use with a medical file carrier, comprising:
(a) connecting a first side of a piece of material to a wall of the material;
(b) connecting a second side of the piece of material to the wall to form a pocket configured to removably accept a portion of a medical file carrier; and
(c) forming an orifice in the wall, the orifice configured to expose a status identifier of the medical file carrier.

23. The method of claim 22, wherein the material comprises a non-porous material.

24. The method of claim 22, wherein at least one of connecting the first side and connecting the second side comprises forming a threaded section with a surger.
